(19) United States
(12) Patent Application Publication
(10) Pub. No.: US 2007/0220071 A1
(43) Pub. Date: Sep. 20, 2007

(54) Storage system, data migration method and server apparatus

(75) Inventors: Tomoya Anzai, Sagamihara (JP); Yoji Nakatani, Yokohama (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 11/410,573

(22) Filed: Apr. 24, 2006

(30) Foreign Application Priority Data
Mar. 15, 2006 (JP) 2006-070210

(51) Int. Cl. G06F 17/30

(52) U.S. Cl. 707/204

(57) ABSTRACT

Provided is a storage apparatus, a data migration method, and a server apparatus, capable of maintaining a snapshot of a logical volume before and after the migration of data in the logical volume. A server apparatus, when migrating data in a first volume allocated to the server apparatus to one or more volumes in a storage apparatus allocated to another server apparatus, keeps the data in the storage apparatus allocated to the storage apparatus even after the migration of the data in the first volume, or also migrates data in the second volume to the one or more volumes allocated to the other server apparatus.

### CROSS-REFERENCES TO RELATED APPLICATIONS

This application relates to and claims priority from Japanese Patent Application No. 2006-070210, filed on Mar. 15, 2006, the entire disclosure of which is incorporated herein by reference.

### BACKGROUND

The present invention relates to a storage system, a data migration method, and a server apparatus, and is suitable for use in a storage system employing, for example, global name space technology.

In recent years, a method called global name space has been proposed as a file management method. Global name space is a technique that collects name spaces of a plurality of NAS (Network Attached Storage) apparatuses to constitute one name space, and is now under consideration for the next standard technology for NFS (Network File System), version 4. For example, U.S. Pat. No. 6,671,773 describes a NAS apparatus that provides a single NAS image.

In storage systems employing the above-mentioned global name space technology, data in any logical volumes (file systems) managed by a NAS apparatus is migrated to a logical volume managed by another NAS apparatus in order to distribute the loads between the NAS apparatuses.

At this time, the path in the global name space for the migrated file system (global path) is not changed, and a client apparatus, which accesses the NAS servers using global paths, can continue to access them via the same paths after the data migration. In the global name space, the correspondence between global paths and local paths is managed using a particular management table (hereinafter, referred to as a “global name space management table”).

Meanwhile, conventional NAS apparatuses and storage apparatuses have, as one of their functions, a snapshot function that keeps an image of a designated primary volume (a logical volume used by a user) at the point in time of reception of a snapshot creation instruction. The snapshot function is used to restore a primary volume at a desired point in time, when data is erased because of human error or when one wishes to restore a file system to that point in time.

An image of a primary volume kept by the snapshot function does not contain all the data in the primary volume at the point in time when there was the snapshot creation instruction, but consists of data in the current primary volume, and differential data kept in a dedicated logical volume called a differential volume.

The differential data is the difference between data in the primary volume at the point in time of receipt of a snapshot creation instruction and that in the current primary volume. The state of the primary volume at the point in time of the snapshot creation instruction is restored based on the differential data and the current primary volume.

Accordingly, the snapshot function has the advantage of it being possible to restore a primary volume at the point in time of the snapshot creation instruction, using a smaller storage capacity compared to the case where the content of the primary volume is stored as it is. U.S. Patent Publication No. 2004-0186900-A1 discloses a technology capable of obtaining a plurality of generations of snapshots.

### SUMMARY

The inventors found that in conventional storage systems, when data in any logical volumes in a NAS apparatus is migrated to a logical volume managed by another NAS apparatus in order to distribute the loads between the NAS apparatuses as stated above, it is necessary to consider the association between the migration object logical volume and its associated volume.

For example, when the migration object is a primary volume and the associated volume is a differential volume, the association between the primary volume and the differential volume has conventionally not been considered when data in the primary volume is migrated. In other words, even if a snapshot has been obtained up to that point in time for the primary volume, the differential data necessary for referring to the snapshot, and management information on the snapshot have not been migrated.

Therefore, there has been a problem in that when processing for migrating data in a primary volume to a logical volume managed by another NAS apparatus is performed, snapshots obtained for the primary volume before the data migration cannot be maintained.

The present invention has been made in consideration of the above point, and an object of the present invention is to provide a storage system, a data migration method, and a server apparatus; capable of, even after data in a first volume, from among a first volume and a second volume associated with each other and managed by a server apparatus, is migrated to a volume managed by another server apparatus, continuing the association between data in the first and second volumes after the migration of the data in the first volume.

In order to achieve the object, the present invention provides a storage system having a plurality of server apparatuses each managing associated first and second volumes in a storage apparatus allocated to each server apparatus, each server apparatus including a data migration unit that migrates, based on an external instruction, data in the first volume to a volume in a storage apparatus allocated to another server apparatus from among the plurality of server apparatuses, wherein the data migration unit, when data in the first volume from among the associated first and second volumes is migrated to a volume in a storage apparatus allocated to another server apparatus from among the plurality of server apparatuses, keeps the data in the storage apparatus allocated to its own server apparatus even after the migration of the data in the first volume, or also migrates data in the second volume to the volume or another volume from among the plurality of volumes in the storage apparatus allocated to the other server apparatus.

Consequently, in this storage system, data in the associated first and second volumes can be managed by an identical server apparatus, making it possible to quickly and reliably refer to data in both the first and second volumes.

The present invention makes it possible to, even after data in a first volume from among a first volume and a second volume associated with each other and managed by a server apparatus is migrated to a volume managed by another server apparatus, continue the association between data in the first and second volumes after the migration of the data in the first volume.

### BRIEF DESCRIPTION OF THE DRAWINGS

FIG. 1 is a block diagram illustrating a storage system according to first and second embodiments of the present invention.

FIG. 2A and FIG. 2B are conceptual diagrams illustrating global name space management tables.

FIG. 3 is a conceptual diagram illustrating a global name space.

FIG. 4 is a conceptual diagram illustrating a local name space.

FIG. 5A and FIG.5B are conceptual diagrams illustrating block copy management tables.

FIG. 6 is a conceptual diagram provided to explain a differential snapshot.

FIG. 7 is a conceptual diagram illustrating a block usage management table.

FIG. 8A and FIG. 8B are block diagrams provided to briefly explain migration processing according to the first embodiment.

FIG. 9 is a schematic diagram illustrating a file system management screen.

FIG. 10 is a schematic diagram illustrating a migration detail setting screen.

FIG. 11 is a flowchart indicating a first migration procedure.

FIG. 12A and FIG. 12B are block diagrams provided to briefly explain migration processing according to the second embodiment.

FIG. 13 is a flowchart indicating a second migration procedure.

FIG. 14 is a flowchart indicating the specific content of data migration processing for a primary volume and a differential volume.

### DETAILED DESCRIPTION OF THE PREFERRED EMBODIMENTS

Embodiments of the present invention are described below with reference to the drawings.

### (1) First Embodiment

(1-1) Entire Configuration of a Storage System According to the Embodiment

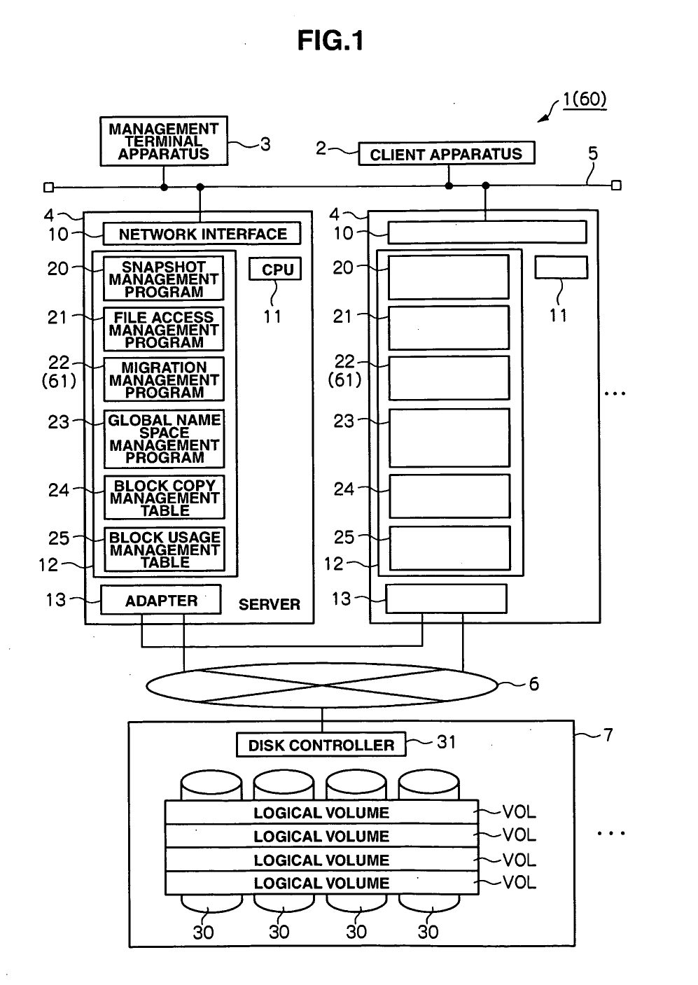

FIG. 1 shows a storage system according to the embodiment as a whole. The storage system 1 includes a client apparatus 2, a management terminal apparatus 3, and a plurality of NAS servers 4 connected via a first network 5, and the NAS servers 4 connected to storage apparatuses 7 via a second network 6.

The client apparatus 2 is a computer apparatus having information processing resources such as a CPU (Central Processing Unit) and memory, etc., and may be a personal computer, workstation, mainframe computer, or similar. The client apparatus 2 includes information input devices (not shown), such as a keyboard, switch, pointing device, microphone, etc., and information output devices (not shown), such as a monitor display, speaker, or similar.

The management terminal apparatus 3, as with the client apparatus 2, is a computer apparatus having information processing resources such as a CPU (Central Processing Unit) and memory, etc., and may be a personal computer, workstation or mainframe computer. The management terminal apparatus 3 monitors the operation/failure status of the storage apparatuses 7, displays required information on a display, and also controls the storage apparatus 7's operation according to an operator's instructions. As described later, a user can set the content of a migration and, if necessary, can also change it, using the management terminal apparatus 3.

The first network 5 may be a SAN (Storage Area Network), a LAN (Local Area Network), the Internet, a public line or a dedicated line. Communication between the client apparatus 2 and the NAS servers 4 via the first network 5 is conducted according to Fiber Channel Protocol if the first network 5 is a SAN, and TCP/IP (Transmission Control Protocol/Internet Protocol) if the first network 5 is a LAN.

Each NAS server 4 has a function that manages logical volumes VOL in the storage apparatus 7 allocated to the NAS server itself, and includes a network interface 10, a CPU 11, memory 12, and adapter 13. The network interface 10 is an interface for the CPU 11 to communicate with the client apparatus 2 and the management terminal apparatus 3 via the first network 5, and sends/receives various commands to/from the client apparatus 2 and the management terminal apparatus 3.

The CPU 11 is a processor that controls the entire operation of the NAS server 4, and performs various control processing as described later by executing various control programs stored in the memory 12.

The memory 12 stores various control programs including a snapshot management program 20, a file access management program 21, and a migration management program 22, and various management tables including a global name space management table 23, a block copy management table 24, and a block usage management table 25.

The snapshot management program 20 is a program for the management (creation, deletion, etc.) of a plurality of generations of snapshots, the management (creation, reference, update and deletion, etc.) of the block copy management table 24 and the block usage management table 25 is conducted based also on the snapshot management program 20.

The file access management program 21 is a program for managing the logical volumes VOL described later (creating and mounting file systems, processing client access, and communicating with the management terminal apparatus 3, etc.), and managing (creating, referring, updating, and deleting, etc.) the global name space management table 23. The migration management program 22 is a program relating to logical volume migration processing, such as copying or deleting data in a logical volume VOL.

The global name space management table 23, the block copy management table 24 and the block usage management table 25 are described later.

The adapter 13 is an interface for the CPU 11 to communicate with the storage apparatuses 7 via the second network 6. The second network 6 may be a Fiber Channel, SAN, or the like. Communication between the NAS servers 4 and the storage apparatuses 7 via the second network 6 is performed according to Fiber Channel Protocol if the second network 6 is a Fiber Channel or a SAN.

Meanwhile, the storage apparatus 7 includes a plurality of disk devices 30, and a disk controller 31 for controlling the disk devices 30.

The disk devices 30 may be expensive disk drives such as SCSI (Small Computer System Interface) disks or similar, or inexpensive disk drives such as SATA (Serial AT Attachment) disks or optical disk drives or similar. One or more disk devices 30 provide a storage area where one or more logical volumes VOL are defined. Data is written/read in blocks of a predetermined size to/from the client apparatus 2 from/to these logical volumes VOL.

Each logical volume VOL is assigned a unique identifier (LUN: Logical Unit Number). In this embodiment, data is input/output upon designating an address, which is a combination of the identifier and a unique number assigned to each of the blocks (LBA: Logical Block Address).

Attributes for a logical volume VOL created in the storage apparatus 7 include primary volume, differential volume, and virtual volume.

A primary volume is a logical volume VOL for the client apparatus 2 to read/write data, and can be accessed using a file access function based on the above-described file access management program 21 in the NAS server 4. The differential volume is a logical volume VOL for, upon update of data in a primary volume after a snapshot having been taken, saving data before that update. The client apparatus 2 cannot recognize this differential data.

The virtual volume is a virtual logical volume VOL that does not actually exist. The virtual volume is associated with one or more logical volumes VOL that actually exist. Upon a data input/output request from the client apparatus 2 to a virtual volume, data reading/writing is performed in the logical volumes associated with the virtual volume. A snapshot is created as a virtual volume.

The disk controller 31 includes a CPU and cache memory, and controls data transmission/reception between the NAS servers 4 and the disk devices 30.

The disk controller 31 manages each of the disk devices 30 according to a RAID method.

(1-2) Configurations of Various Management Tables

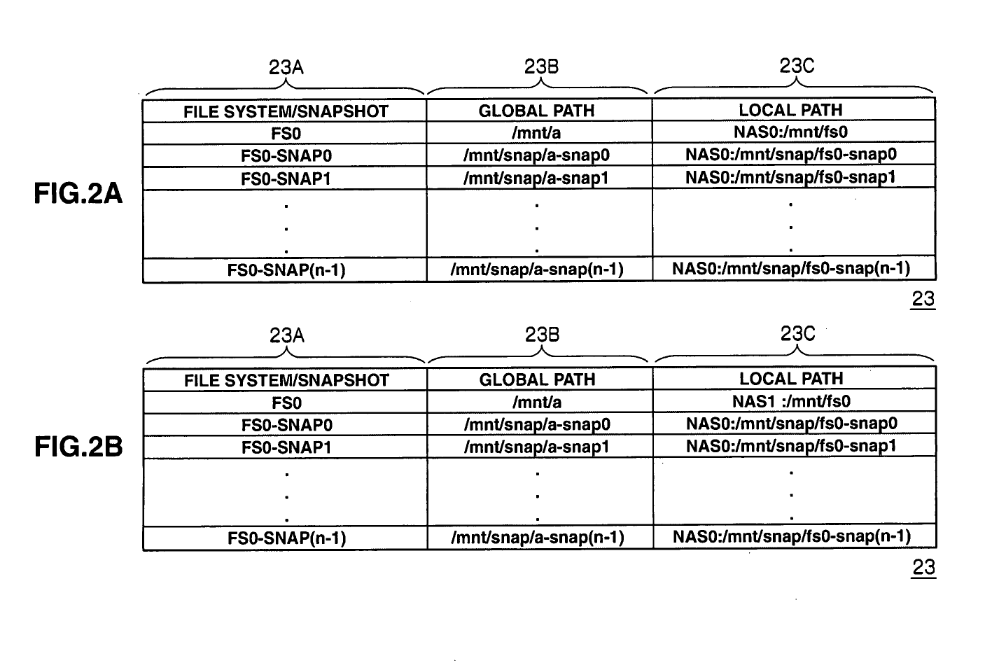

FIG. 2A shows the specific configuration of the global name space management table 23. The global name space management table 23 is a table for managing global name spaces and local name spaces for management object file systems and snapshots in association with each other, and is provided with a “file system/snapshot” field 23A, a “global path” field 23B, and a “local path” field 23C for each of the management object file systems and snapshots.

The “file system/snapshot” field 23A stores the name of the file system or snapshot. The “global path” field 23B stores the global path for the file system or snapshot, and the “local path” field 23C stores the local path for the file system or snapshot.

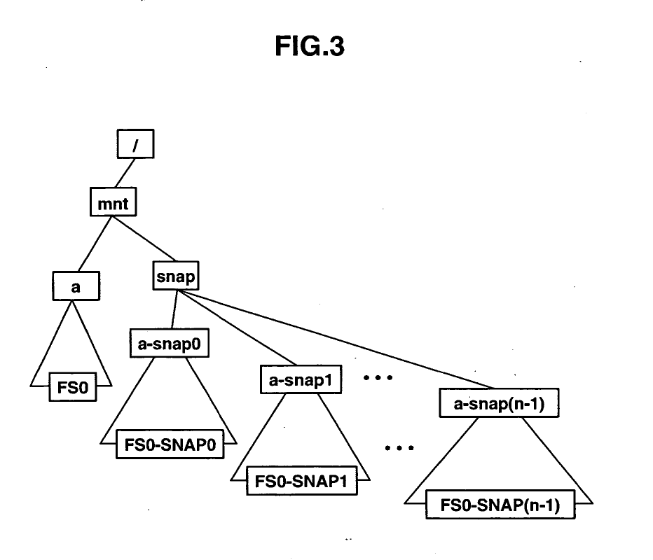

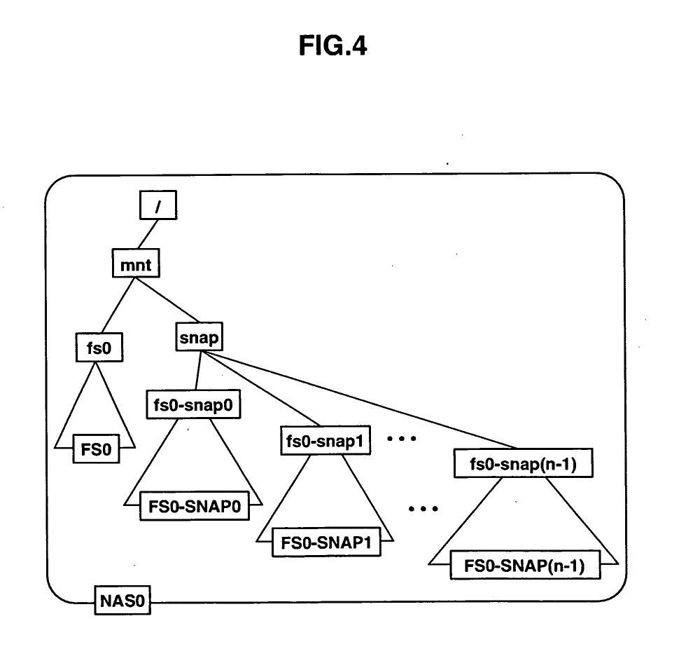

The FIG. 2A example shows that when the global name space is configured as shown in FIG. 3 and the local name space is configured as shown in FIG. 4, the global path for a file system “FS0” is “/mnt/a,” and the local path is “NAS0:/mnt/fs0”, and the global path for a snapshot “FS0-SNAP1” is ”/mnt/snap/a-snap1”, and the local path is “NAS0:/mnt/snap/fs0-snap1”.

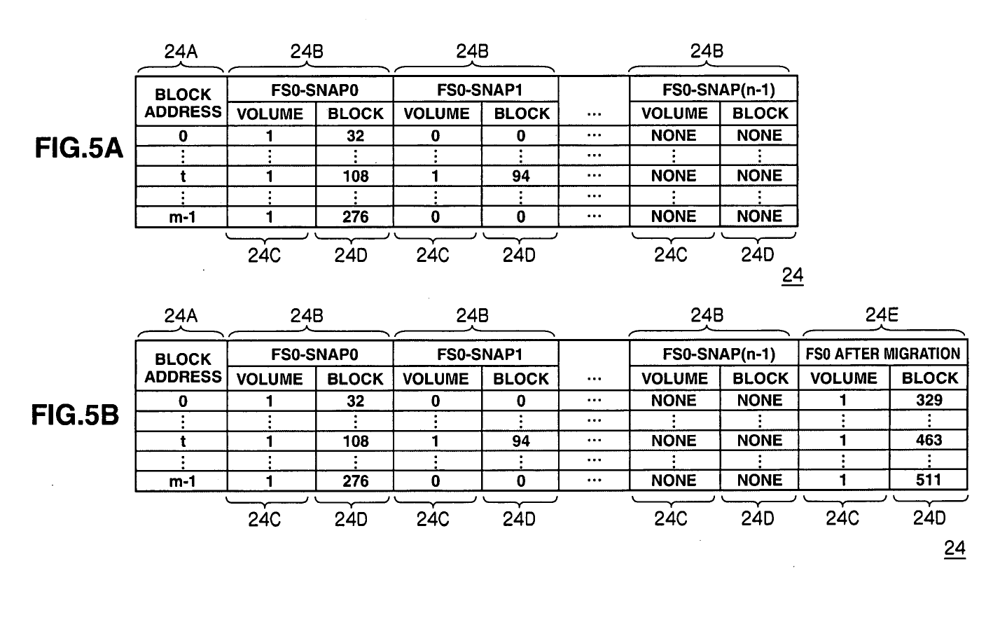

Meanwhile, FIG. 5A shows the specific configuration of the block copy management table 24. The block copy management table 24 is a table for managing the locations storing each block of data for each of a plurality of generations of snapshots, and is provided with a “block address” field 24A and a plurality of snapshot management fields 24B for each of the blocks in a primary volume.

The “block address” field 24A stores a block address in the primary volume. For a block address, an LBA may be used, and when block addresses are collectively managed in multiple blocks, a relative address, like one based on a chunk, which is the management unit, may be used.

The snapshot management fields 24B are respectively provided for a plurality of generations of snapshots that have been obtained or will be obtained in the future, and each has a “volume” field 24C and a “block” field 24D.

The “volume” field 24C stores “0” when the relevant snapshot is created, and then stores “1” (i.e., updates the data from “0” to “1”) when data in a corresponding block in the primary volume is updated and the data before the update is saved in the differential volume.

The “block” field 24D stores “0” when the relevant snapshot is created, and then, when data in a corresponding block in the primary volume is updated and the data before the update is saved in the differential volume, stores the address of the save destination block in the differential volume.

The FIG. 5A example shows that in the snapshot “FS0-SNAP1,” data in a block with the block address “t” in a primary volume is updated after the obtainment of the snapshot (the value in the “volume” field 24C is “1”), and the data before the update is saved in a block with the block address “94” in a differential volume (the value in the “block” field 24D is “94”).

The example further shows that in the snapshot “FS0-SNAP1” data in a block with the block address “m-1” is not updated after the obtainment of the snapshot (the value in the “volume” field 24C is “0”), and the data is stored in the block with the block address “m-1” in the primary volume.

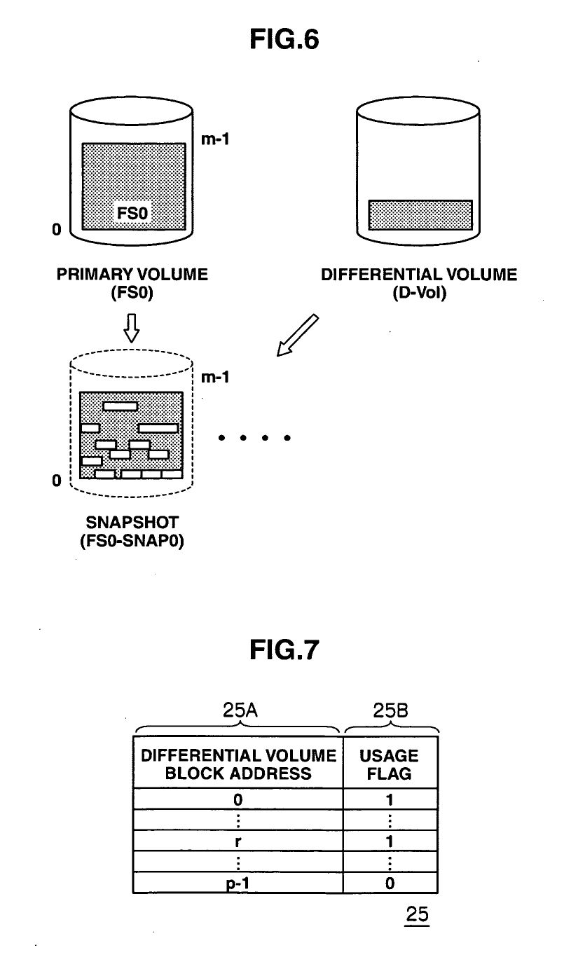

Accordingly, as shown in FIG. 6, the snapshot “FS0-SNAP1” can be obtained by, for blocks with the value “1” in the “volume” field 24C of the block copy management table 24 (including the block with the address block “t”), referring to data in the blocks with the corresponding addresses in a differential volume (D-VOL), and for blocks with the value “0” in the “volume” field 24C of the block copy management table 24 (including blocks with block addresses “0” and “m-1”), referring to data in the blocks with the corresponding block addresses in the primary volume (“FS0”).

Meanwhile, FIG. 7 shows the specific configuration of the block usage management table 25. The block usage management table 25 is a table for managing the usage of the blocks in a differential volume, and is provided with a “block address” field 25A and a “usage flag” field 25B for each of the blocks in the differential volume.

The “block address” field 25A stores addresses for the blocks. The “usage flag” field 25B stores 1-bit usage flags, each of which is set to “0” if the relevant block is unused (differential data is not stored or has been released), or “1” if the relevant block is used (differential data is stored).

The FIG. 7 example shows that the block with the block address “r” in the differential volume is used, and the block with the block address “p-1” is unused.

(1-3) Migration Processing

Next, the content of migration processing in this storage system will be explained.

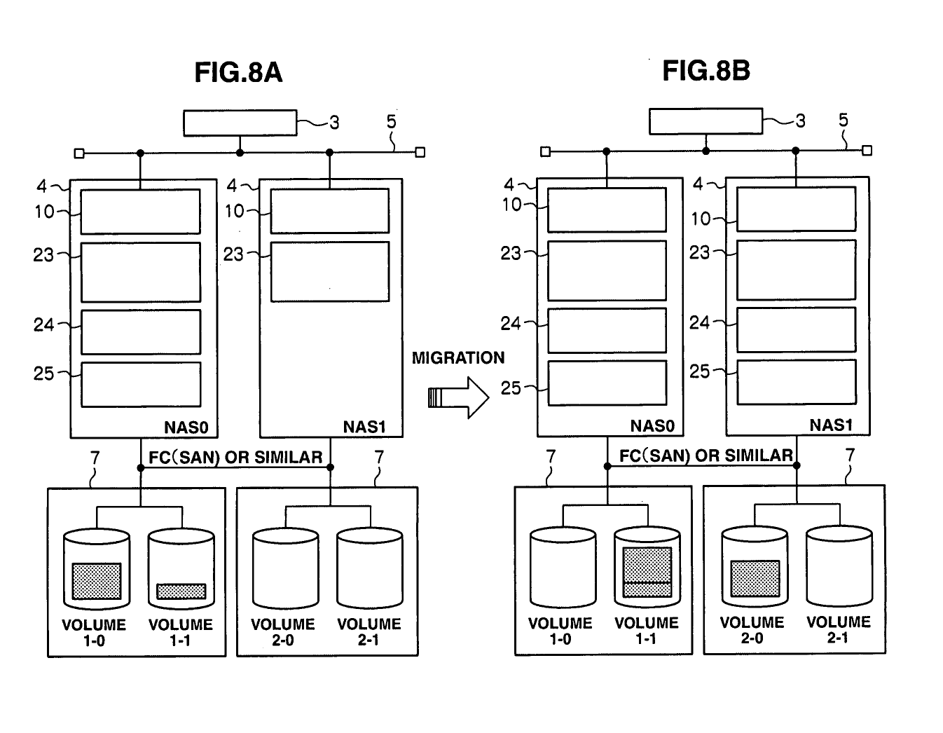

The storage system 1 is characterized in that when data in a primary volume (“VOLUME 1-0”) in a first storage apparatus 7 allocated to a first NAS server (NAS0″) as shown in FIG. 8A is migrated to a logical volume (“VOLUME 2-0”) in a second storage apparatus 7 allocated to a second NAS server 4 (“NAS1”), all data in the primary volume is concurrently migrated to a differential volume (“volume 1-1”) storing differential data for the snapshots obtained for the primary volume and is kept there as shown in FIG. 8B. Thus, the storage system 1 makes it possible to maintain the snapshots obtained up to that point in time based on the primary volume data and differential data stored in the differential volume, and snapshot management information kept by the first NAS server 4 (management information that associates the primary volume and the differential volume with each other; specifically, the block copy management table 24).

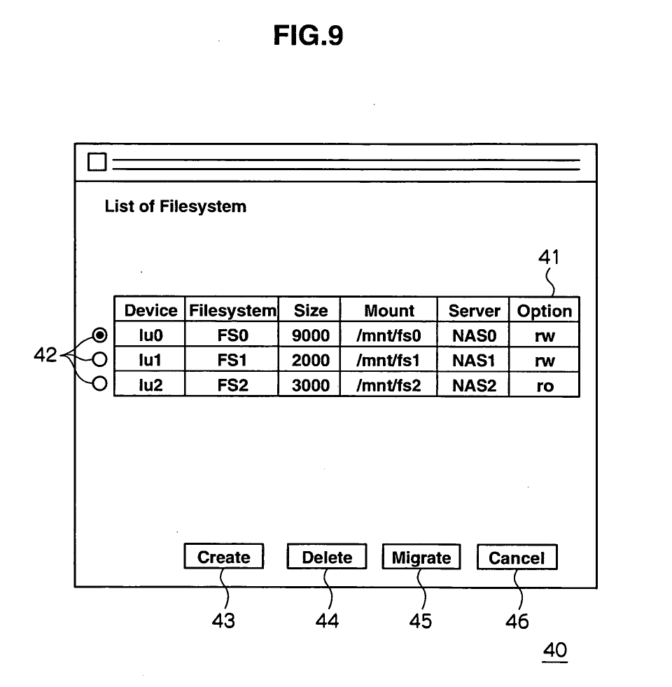

FIG. 9 shows a file system management screen 40, which is a GUI (Graphical User Interface) screen for setting the content of the above-described migration processing, displayed on the management terminal apparatus 3's display.

This file system management screen 40 displays a list 41 of file systems existing in the storage system 1, which has been obtained by the management terminal apparatus 3 accessing any of the NAS servers 4, and also displays radio buttons 42, each corresponding to one of the file systems, on the left side of the list 41. Consequently, the file system management screen 40 makes it possible to use these radio buttons 42 to select a desired file system from among those listed.

On the lower portion of the file system management screen 40, a “Create” button 43, a “Delete” button 44, a “Migrate” button 45, and a “Cancel” button 46 are provided.

The “Create” button 43 is a button for creating a new file system, and can display a GUI (Graphical User Interface) screen (not shown) for setting the content of a new file system by clicking the “Create” button 43. The “Delete” button 44 is a button for deleting a file system selected using the above-described radio button 42.

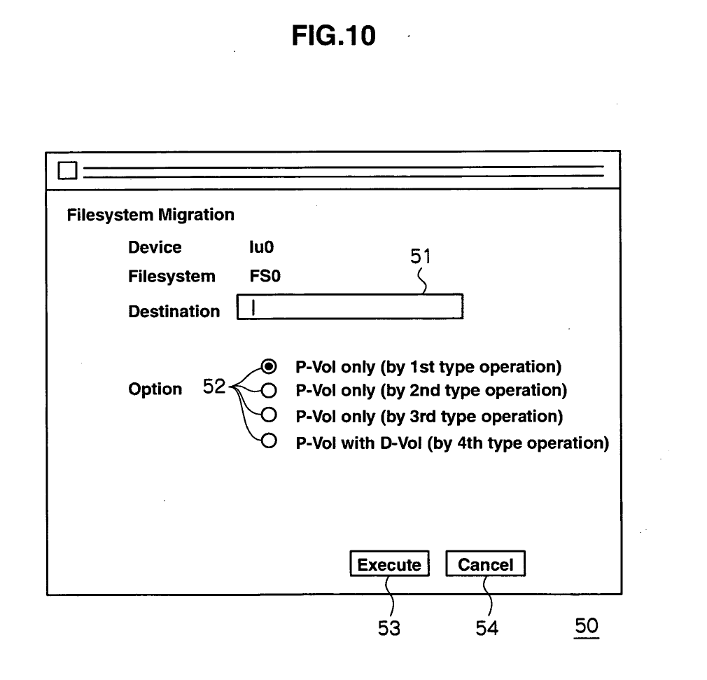

The “Migrate” button 45 is a button for migrating data in a primary volume in a file system selected using the radio button 42 to a desired volume, and can display, on the management terminal apparatus 3's display, a migration detail setting screen 50, as shown in FIG. 10, for setting the migration content for a desired file system by clicking the “Migrate” button 45 after the selection of the file system. The “Cancel” button 46 is a button for deleting the file system setting screen 40 from the management terminal apparatus 3's display.

As shown in FIG. 10, the migration detail setting screen 50 displays the name of the device selected on the file system setting screen 40 (“IuO” in the FIG. 10 example), and the file system name (“FS0” in the FIG. 10 example). A data migration destination designation field 51 is displayed below the file system name. Consequently, a system administrator can input the name of a data migration destination logical volume VOL in this data migration destination designation field 51 to designate the logical volume VOL as the data migration destination.

On the lower side of the data migration destination designation field 51, several types of migration processing “P-Vol only (by 1^{st} type operation)” “P-Vol only (by 2^{nd} type operation)” and others in the FIG. 10 example), and radio buttons 52 respectively corresponding to these processing types are shown. The system administrator can set the desired migration processing type by selecting the corresponding radio button 52.

In the lower right portion of the migration detail setting screen 50, an “Execute” button 53 and a “Cancel” button 54 are shown. The “Execute” button 53 is a button for making the storage system 1 execute a migration. Upon setting the data migration destination logical volume VOL and the migration processing type and then clicking this “Execute” button 53, the storage system 1 executes the set migration processing. The “Cancel” button 54 is used to cancel the setting content, such as the above data migration destination, and to erase the migration detail setting screen 40 from the management terminal apparatus 3's display.

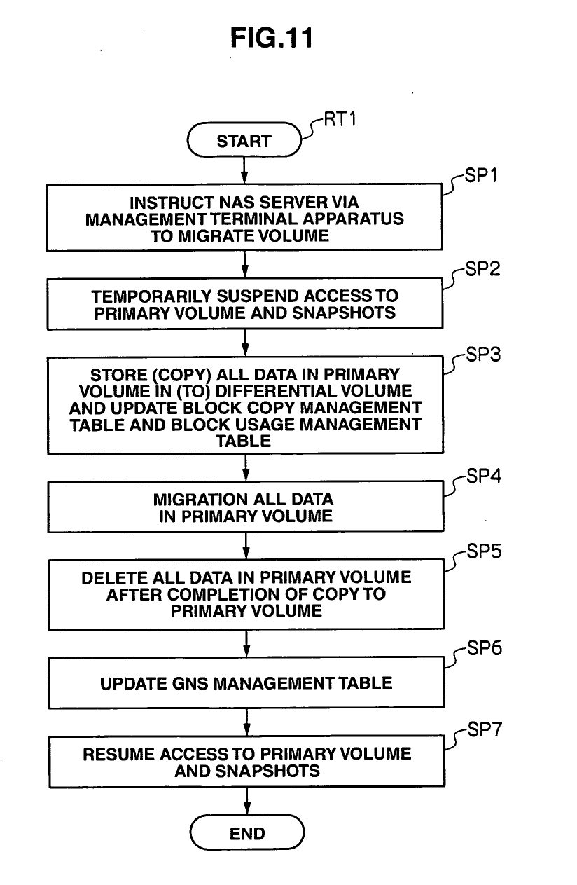

FIG. 11 is a flowchart indicating a sequence of processes relating to migration processing in the aforementioned storage system 1 according to the embodiment (hereinafter, referred to as the “first migration processing procedure RT”).

The management terminal apparatus 3, upon the migration content being set using the file system management screen 40 and the migration detail setting screen 50 as described above and then the “Execute” button 53 (FIG. 10) in the migration detail setting screen 50 being clicked, provides the NAS server 4 that manages the data migration source primary volume (hereinafter, referred to as the “destination source managing NAS server”) with an instruction to execute the set migration processing content (hereinafter, referred to as the “migration execution instruction”) (SP1).

The CPU 11 in the destination source managing NAS server 4, upon receipt of the migration execution instruction, based on the migration management program 22, first provides the file access management program 21 with an instruction to temporarily suspend access to the data migration source primary volume and the snapshots obtained up to that point in time for the primary volume (SP2). Accordingly, the migration source managing NAS server 4, even if receiving an access request to the primary volume and snapshots from the client apparatus 2, will temporarily suspend data input/output processing in response to the request. Here, “temporarily suspend” means that a response to a data input/output request, etc., from the client apparatus 2 will be somewhat delayed until the resumption of access to the primary volume, etc., as described later.

Subsequently, the CPU 11 in the destination source managing NAS server 4, based on the migration processing program 22, copies all data in the primary volume to the differential volume, and based on the snapshot management program 20, updates the block copy management table 24 and the block usage management table 25 (SP3).

More specifically, the CPU 11, referring to the block usage management table 25 for the differential volume, confirms unused blocks (blocks with “0” stored in the “usage flag” field 25B) in the differential volume. Then the CPU 11 sequentially stores data in the respective blocks in the primary volume to the unused blocks in the differential volume. At the same time, the CPU 11 changes the usage flags to “1” in the usage flag field 25B of the block usage management table 25 for the blocks to which copy of data from the primary volume has been completed.

The CPU 11, as shown in FIG. 5B, also adds a snapshot management field 24E (snapshot management field for “FS0 AFTER MIGRATION” in FIG. 5B) to the block copy management table 24 for the data image of the primary volume at the time when the data has been copied to the differential volume (“FS0 AFTER MIGRATION”). The CPU 11 stores “1” in every “volume” field 24C of the added snapshot management field 24E, and stores in every “block” field 24D the address of the block in the differential volume to which data in the block with the corresponding address in the primary volume has been copied.

Subsequently, the CPU 11 in the migration source managing server 4, based on the migration processing program 22, sequentially migrates, in blocks, all data in the primary volume to the migration destination logical volume VOL set using the migration detail setting screen 50 described above with reference to FIG. 10 (SP4). The above-described data migration may be performed via the first network 5 through the NAS servers 4, or via the second network 6, not through the NAS servers 4.

The CPU 11 in the migration source managing server 4, upon the completion of migration of all data in the primary volume to the data migration destination logical volume VOL, deletes all the data for which the migration has been completed from the primary volume (SP5). The sequential data migration processing for the primary volume may start before the temporary suspension of access to the primary volume at step SP2.

Then, the CPU 11 in the NAS server that manages the data migration destination logical volume VOL (hereinafter, referred to as the “migration destination managing NAS server”), based on the file access management program 21, updates the global name space management table 23 in its own apparatus (SP6). More specifically, the CPU 11, as shown in FIG. 2B, changes the NAS server device name portion of the local path for the file system for which data migration has been conducted (in the FIG. 2B example, changes “NAS0” to “NAS1”).

At the same time, the CPU 11 in the migration destination managing NAS server 4 accesses the other NAS servers 4 including the migration source managing NAS server 4 via the first network 5 or the second network 6 to change the respective global name space management table 23 in the other NAS servers 4 to be the same as the global name space management table 23 in its own apparatus.

Subsequently, the CPU 11 in the migration destination managing NAS server 4, based on the file access management program 21, recognizes the logical volume VOL to which the data migration has been performed as a primary volume, and resumes access to the primary volume (SP7). At the same time, the CPU 11 in the migration source managing NAS server 4, based on the snapshot management program 20, resumes access to the snapshots of the data migration source primary volume obtained before the data migration (SP7).

The CPU 11 in the migration source managing NAS server 4, upon receipt from the client apparatus 2 of a request to refer to a snapshot of the primary volume obtained before the data migration, first judges whether or not the migration of the data in the primary volume has been conducted, based on the block copy management table 24. More specifically, the CPU 11 judges whether or not an “FS0 AFTER MIGRATION” snapshot management field 24E has been added to the block copy management table 24, and judges the primary volume data migration as having not been conducted if it is not added, and judges the primary volume data migration as having been conducted if it is added.

In this example where the primary volume migration has been conducted, the CPU 11 in the migration source managing NAS server 4 will obtain an affirmative result in this judgment. Consequently, the CPU 11 in the migration source managing server 4 reads data in the blocks of the snapshot matching the reference request from the differential volume using the block copy management table 24 after migration, described above with reference to FIG. 5B, and sends it to the client apparatus 2.

At this time, for a block with “0” stored in its “volume” field 24C of the snapshot management field 24B in the block copy management table 24, the CPU 11 in the migration source managing server 4 refers to the address stored in the “block” field 24D of the snapshot management field 24E in the “FS0 AFTER MIGRATION” and reads data from the block with that address in the differential volume.

(1-4) Effect of the Embodiment

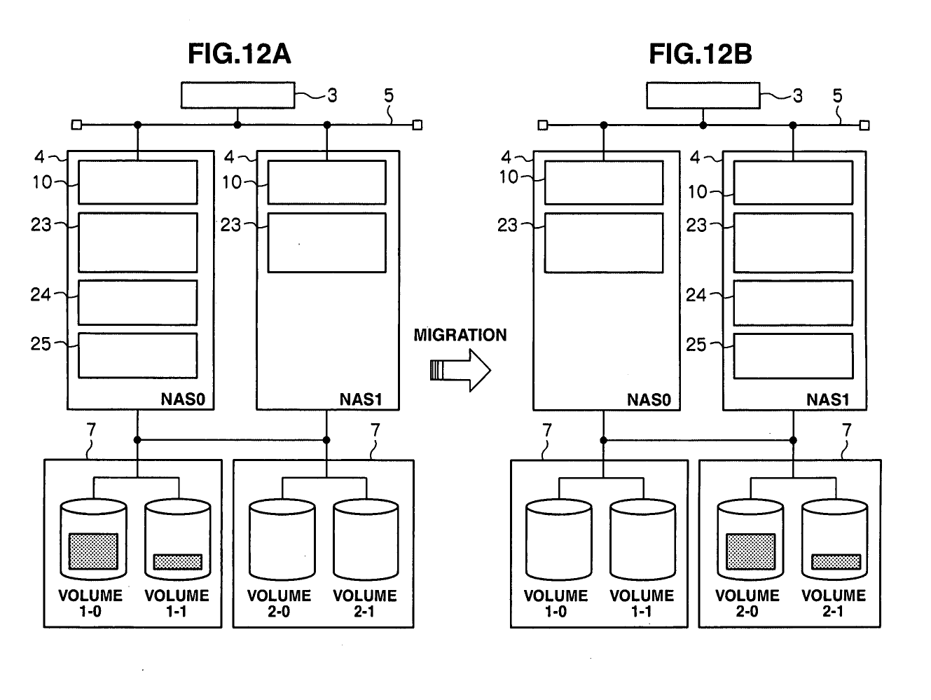

As described above, in the storage system 1 according to the embodiment, when data in a primary volume managed by a first NAS server 4 is migrated to a logical volume managed by a second NAS server 4, all data in the primary volume is copied concurrently to the corresponding differential volume and kept therein after the data migration as shown in FIG. 12B, making it possible to maintain the snapshots obtained up to that point in time based on the primary volume data and differential data stored in the differential volume and the block copy management table 24 held by the first NAS server.

Accordingly, in the storage system 1, data in associated primary and differential volumes can always be managed by the identical first NAS server 4, and data in both the primary volume and the differential volume can always be referred to promptly and reliably, making it possible to maintain the data association between the primary volume and the differential volume after the primary volume data migration.

(1-5) Other Embodiments

The above-described first embodiment relates to the case where all data in a primary volume is migrated to a differential volume at the time of a data migration of the primary volume. However, the present invention is not limited to that case, and only data necessary for reference to the snapshots may be copied to the differential volume. More specifically, whether or nor each of the blocks in a primary volume is used for reference to the snapshots obtained up to that point in time (whether or not “0” is stored in the “volume” field 24C of the snapshot management field 24B in the block copy management table 24) may be confirmed based on the block copy management table 24, and only data used for reference to the snapshots may be copied to the differential volume.

The above-described first embodiment relates to the case where all data in a primary volume is migrated to a differential volume at the time of a data migration of the primary volume. However, the present invention is not limited to that case, and data in the primary volume may remain in the primary volume as it is. In this case, the primary volume that remains as it is will be remounted as a read-only volume. Also, when data remains in the primary volume, only data in the blocks used for reference to the snapshots may remain in the primary volume as described above.

The above-described first embodiment relates to the case where processing is performed so that all data in a primary volume is simply migrated to a migration destination logical VOL. However, the present invention is not limited to that case, and after migration of data from the primary volume to another logical volume, a snapshot of the logical volume at that time may be created and kept in the data migration destination.

### (2) Second Embodiment

In FIG. 1, reference numeral 60 indicates an entire storage system according to a second embodiment of the present invention. This storage system 60 has the same configuration as the storage system 1 according to the first embodiment, except that the configuration of the migration management program 61 is different from that of the migration management program 22 according to the first embodiment.

In this storage system 60, when data in a primary volume (“VOLUME 1-0”) in the first storage apparatus 7 managed by the first NAS server 4 (“NAS0”) as shown in FIG. 12A is migrated to a logical volume VOL (“VOLUME 2-0”) in the second storage apparatus 7 managed by the second NAS server 4 (“NAS1”), all data in the primary volume and all data in the corresponding differential volume (all differential data) is migrated respectively to the first logical volume VOL (“VOLUME 2-0”) and a second logical volume VOL (“VOLUME 2-1”) in the second storage apparatus 7. At the same time, in the storage system 60, the block copy management table 24 and the block usage management table 25, kept by the first NAS server 4, for managing the snapshots obtained up to that point in time for that primary volume are copied to the block copy management table 24 and the block usage management table 25 in the second NAS server 4.

Thus, the storage system 60 makes it possible to continue to maintain the snapshots of the primary volume obtained up to that point in time in the second NAS server 4 while distributing the loads for the first NAS server 4.

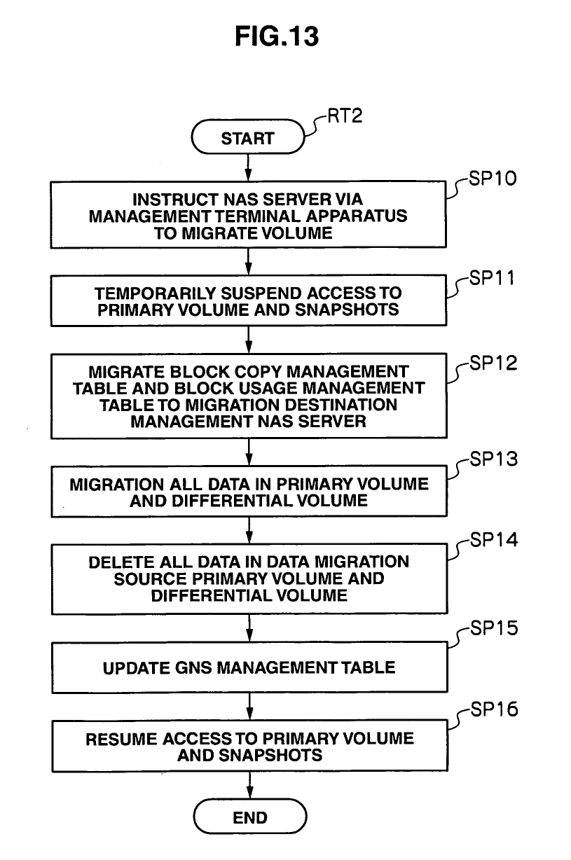

FIG. 13 is a flowchart indicating a sequence of processes relating to migration processing in the storage system 60 according to the second embodiment (hereinafter, referred to as the “second migration procedure RT2”).

In this storage system 60, when migration processing is performed, a migration execution instruction is provided from the management terminal apparatus 3 to the migration source managing NAS server 4 as in the aforementioned steps SP1 and SP2 in the first migration procedure RT1, and based on the migration execution instruction, the migration source managing NAS server 4 temporarily suspends access to the data migration source primary volume and the snapshots obtained up to that point in time for the primary volume.

Subsequently, the CPU 11 in the migration source managing NAS server 4, based on the migration management program 61 (FIG. 1), sends data in the block copy management table 24 and the block usage management table 25 in its own apparatus to the migration destination managing NAS server 4 and has the migration destination managing NAS server copy the block copy management table 24 and block usage management table 25 to the block copy management table 24 and block usage management table 25 in the migration destination managing NAS server 4 (SP12).

Then, the CPU 11, based on the migration management program 61, controls the first and second storage apparatuses 7 to migrate all data in a primary volume in the first storage apparatus 7 to a first logical volume VOL set as the migration destination using the migration detail setting screen 50 described above with reference to FIG. 10, and to also migrate all data in a differential volume in the first storage apparatus 7 (all differential data) to a second logical volume VOL set as the migration destination using the migration detail setting screen 50 (SP13).

Subsequently, the CPU 11 in the migration source managing NAS server 4, as in the steps SP5 and SP6 in the aforementioned first migration procedure RT1 (FIG. 11), deletes all data in the data migration source primary volume and all data in the differential volume and the block copy management table 24 and the block usage management table 25 (SP14), and then updates the global name space management table 23 in each of its own apparatuses and other NAS servers 4 (SP15).

Then, the CPU 11 in the migration source managing NAS server 4, based on the file access management program 21, recognizes the logical volume VOL, which is the migration destination for data in the primary volume, as a new primary volume, and resumes access to the primary volume (SP16), and also recognizes the logical volume VOL, which is the migration destination for the differential volume, as a new differential volume, and resumes access to the differential volume (SP16).

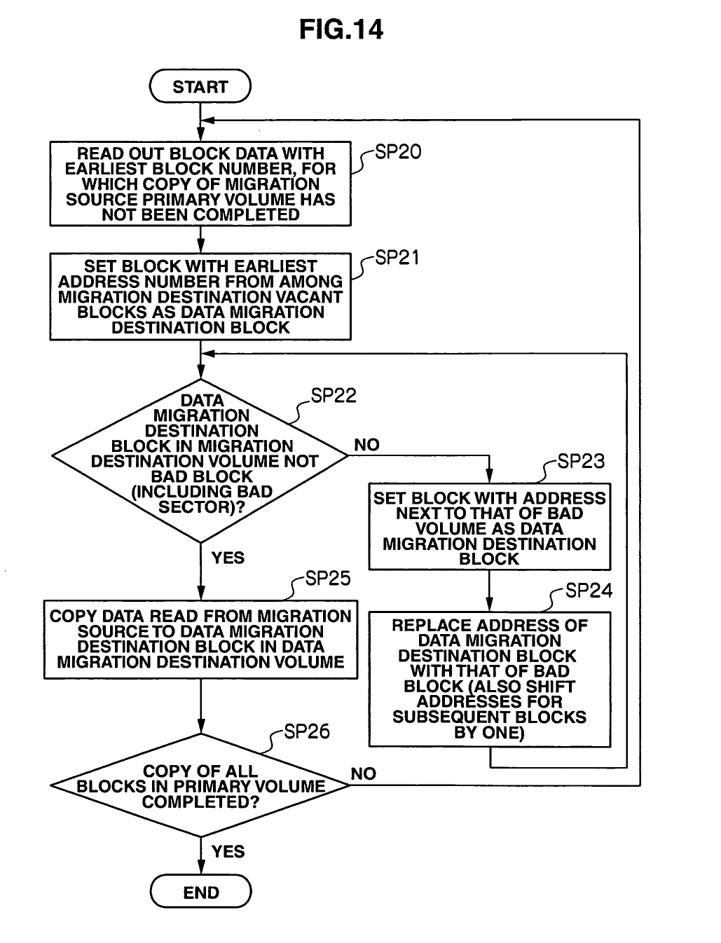

FIG. 14 is a flowchart indicating the specific procedure of step SP 13 in the second migration procedure RT2. Here, only the processing for a primary volume is described, but the same type of processing may concurrently be performed on a differential volume.

The CPU 11 in the migration source managing NAS server 4, when proceeding to step SP13 in the second migration procedure RT2, controls the first storage apparatus 7 based on the migration management program 61 (FIG. 1) to first read data from the block with the smallest block address number from among the blocks in the data migration source primary volume for which copy has not been completed yet (SP20).

Next, the CPU 11 in the migration source managing NAS server 4 accesses the migration destination managing NAS server 4 to select, from among the blocks that are included in the logical volume set as the data migration destination and are storing no data (hereinafter, referred to as vacant blocks), the vacant block with the smallest block address number as the data migration destination block (hereinafter, referred to as “data migration destination block”) (SP21).

Next, the CPU 11 in the migration source managing NAS server 4 judges whether or not the data migration destination block selected at step SP21 is a block with a failure (including a bad sector) (hereinafter, referred to as a “bad block”) (SP22).

The CPU 11 in the migration source managing NAS server 4, upon an affirmative result in this judgment, selects the block with the block address next to the bad block in the data migration destination logical volume VOL as the data migration destination block (SP23), and then replaces the block address of the data migration destination block newly selected at step SP23 with the block address of the bad block. As stated above, the CPU 11 in the migration source managing NAS server 4 sequentially shifts the block numbers by one for the blocks having the block numbers subsequent to the data migration source block newly selected at step SP23 (SP24).

Meanwhile, the CPU 11 in the migration source managing NAS server 4, upon a negative result at step SP22, controls the first and second storage apparatuses 7 to send data read from the data migration source primary volume at step SP20 to the second storage apparatus 7 and have the data copied in the data migration destination block in the second storage apparatus 7 selected at step SP21 or step SP23 (SP 25).

The CPU 11 in the migration source managing NAS server 4 then judges whether or not copy of all data in all the blocks in the primary volume, which is the data migration source, has been completed (SP26), and upon a negative result, returns to step SP20. The CPU 11 in the migration source managing NAS server 4 repeats the same processing until the copy of all data in all the blocks in the primary volume has been completed and the CPU 11 obtains an affirmative result at step SP26 (SP20 to SP26).

Then, the CPU 11 in the migration source managing NAS server 4, upon an affirmative result in the judgment at step SP 26, ends the processing at step SP13 in the second migration procedure RT2.

As described above, in the storage system 60, concurrently with the migration of data in a primary volume, data in the corresponding differential volume is migrated to a logical volume in the storage apparatus 7 managed by the migration destination managing NAS server 4, and management information on the snapshots of the primary volume (block copy management table 24) is also migrated to the migration destination managing NAS server 4, making it possible to maintain the snapshots of the primary volume after the primary volume data migration.

### (3) Other Embodiments

The above-described first and second embodiments relate to the case where a data migration unit that migrates, based on an external instruction, data in a first logical volume to a volume in the storage apparatus 7 allocated to another NAS server 4 consists of the CPU 11 and the migration management program 25, etc., in the NAS server 4. However, the present invention is not limited to that case, and a broad range of configurations other than those in the above embodiments can be used.

What is claimed is:

1. A storage system having a plurality of server apparatuses each managing a plurality of volumes in a storage apparatus allocated to each server apparatus,
each server apparatus comprising a data migration unit that migrates, based on an external instruction, data in a volume from among the plurality of volumes to a volume from among the plurality of volumes in a storage apparatus allocated to another server apparatus from among the plurality of server apparatuses,
wherein the data migration unit, when migrating data in a first volume from among a first volume and a second volume associated with each other, from among the plurality of volumes, to a volume from among the plurality of volumes in a storage apparatus allocated to another server apparatus from among the plurality of server apparatuses, keeps the data in the storage apparatus allocated to its own server apparatus even after the migration of the data in the first volume, or also migrates data in the second volume to the volume or another volume from among the plurality of volumes in the storage apparatus allocated to the other server apparatus.

2. The storage system according to claim 1, wherein, when migrating the data in the first volume to the volume in the storage apparatus allocated to the other server apparatus, if the data is kept in the storage apparatus allocated to its own server apparatus even after the migration of the data in the first volume, the data migration unit holds management information that associates the first and second volumes in its own server apparatus, and if the data in the second volume is also migrated to the volume or the other volume in the storage apparatus allocated to the other server apparatus, the data migration unit migrates the management information that associates the first and second volumes to the other server apparatus.

3. The storage system according to claim 1, wherein, when migrating the data in the first volume to the volume in the storage apparatus allocated to the other server apparatus, if the data is kept in the storage apparatus allocated to its own server apparatus even after the migration of the data in the first volume, the data migration unit holds only necessary data from among the data in the first volume in the storage apparatus.

4. The storage system according to claim 1, wherein, when migrating the data in the first volume to the volume in the storage apparatus allocated to the other server apparatus, if the data is kept in the storage apparatus allocated to its own server apparatus even after the migration of the data in the first volume, the data migration unit copies the data in the first volume to the second volume.

5. The storage system according to claim 4, wherein, when copying the data in the first volume to the second volume, the data migration unit copies only necessary data to the second volume.

6. The storage system according to claim 1,
wherein the first volume is a primary volume used by a user; and
wherein the second volume is a differential volume that stores differential data between a snapshot of the first volume and the current content of the first volume.

7. A data migration method for a storage system having a plurality of server apparatuses each managing a plurality of volumes in a storage apparatus allocated to each server apparatus, the method comprising:
a first step of each server apparatus managing a plurality of volumes in a storage apparatus allocated to each server apparatus; and
a second step of a server apparatus from among the plurality of server apparatuses migrating, based on an external instruction, data in a first volume from among a first volume and a second volume associated with each other, from among the plurality of volumes, to a volume from among the plurality of volumes in a storage apparatus allocated to another server apparatus from among the plurality of server apparatuses and keeping the data in the storage apparatus allocated to the server apparatus even after the migration of the data in the first volume, or also migrating data in the second volume to the volume or another volume from among the plurality of volumes in the storage apparatus allocated to the other server apparatus.

8. The data migration method according to claim 7, wherein the second step includes, when migrating the data in the first volume to the volume in the storage apparatus allocated to the other server apparatus, if the data is kept in the storage apparatus allocated to the server apparatus even after the migration of the data in the first volume, the server apparatus holding management information that associates the first and second volumes in the server apparatus, and if the data in the second volume is also migrated to the volume or the other volume in the storage apparatus allocated to the other server apparatus, the server apparatus migrating the management information that associates the first and second volumes to the other server apparatus.

9. The data migration method according to claim 7, wherein the second step includes, when migrating the data in the first volume to the volume in the storage apparatus allocated to the other server apparatus, if the data is kept in the storage apparatus allocated to the server apparatus even after the migration of the data in the first volume, the server apparatus holding only necessary data from among the data in the first volume in the storage apparatus.

10. The data migration method according to claim 7, wherein the second step includes, when migrating the data in the first volume to the volume in the storage apparatus allocated to the other server apparatus, if the data is kept in the storage apparatus allocated to the server apparatus even after the migration of the data in the first volume, the server apparatus copying the data in the first volume to the second volume.

11. The data migration method according to claim 10, wherein the second step includes, when migrating the data in the first volume to the second volume, copying only necessary data from among the data in the first volume.

12. The data migration method according to claim 7,
wherein the first volume is a primary volume used by a user; and
wherein the second volume is a differential volume that stores differential data between a snapshot of the first volume and the current content of the first volume.

13. A server apparatus that manages a first volume and a second volume associated with each other in a storage apparatus allocated to the server apparatus, comprising
a data migration unit that migrates, based on an external instruction, data in the first volume to a volume in a storage apparatus allocated to another server apparatus,
wherein, when migrating the data in the first volume to a volume in a storage apparatus allocated to another server apparatus, the data migration unit keeps the data in the storage apparatus allocated to the server apparatus even after the migration of the data in the first volume, or also migrates the data in the second volume to the volume or another volume in the storage apparatus allocated to the other server apparatus.

14. The server apparatus according to claim 13, wherein, when migrating the data in the first volume to the volume in the storage apparatus allocated to the other server apparatus, if the data is kept in the storage apparatus allocated to the server apparatus even after the migration of the data in the first volume, the data migration unit holds management information that associates the first and second volumes in the server apparatus, and if the data in the second volume is also migrated to the volume or the other volume in the storage apparatus allocated to the other server apparatus, the data migration unit migrates the management information that associates the first and second volumes to the other server apparatus.

15. The server apparatus according to claim 13, wherein, when migrating the data in the first volume to the volume in the storage apparatus allocated to the other server apparatus, if the data is kept in the storage apparatus allocated to the server apparatus even after the migration of the data in the first volume, the data migration unit holds only necessary data from among the data in the first volume in the server apparatus.

16. The server apparatus according to claim 13, wherein, when migrating the data in the first volume to the volume in the storage apparatus allocated to the other server apparatus, if the data is kept in the storage apparatus allocated to the server apparatus even after the migration of the data in the first volume, the data migration unit copies the data in the first volume to the second volume.

17. The server apparatus according to claim 16, wherein, when copying the data in the first volume to the second volume, the data migration unit copies only necessary data.

18. The server apparatus according to claim 13,
wherein the first volume is a primary volume used by a user; and
wherein the second volume is a differential volume that stores differential data between a snapshot of the first volume and the current content of the first volume.
